(19) United States
(12) Patent Application Publication
(10) Pub. No.: US 2005/0190811 A1
(43) Pub. Date: Sep. 1, 2005

(54) External cavity laser and method for selectively emitting light based on wavelength using aberration-corrected focusing diffractive optical element

(76) Inventor: Russell W. Gruhlke, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/789,544

(22) Filed: Feb. 26, 2004

(51) Int. Cl. H01S 3/08

(52) U.S. Cl. 372/98; 372/99; 372/101

(57) ABSTRACT

An external cavity laser and method for selectively emitting light based on wavelength utilizes a focusing diffractive optical element (DOE) that has been corrected for spherical aberration. The use of the aberration-corrected focusing DOE narrows the cavity spectral response of the external cavity laser, which enables single wavelength/mode lasing and suppresses mode hopping. The aberration-corrected focusing DOE may be transmissive or reflective, depending on the configuration of the external cavity laser.

### FIELD OF THE INVENTION

The invention relates generally to external cavity lasers, and more particularly to an external cavity laser with a diffractive optical element.

### BACKGROUND OF THE INVENTION

One type of conventional external cavity lasers includes a laser diode, a collimating lens and a reflective diffraction grating. The collimating lens collimates the broadly divergent output light from the laser diode. The collimated light is then reflected and diffracted by the diffraction grating based on wavelength so that only the light of a selected wavelength is transmitted back to the laser diode through the collimating lens. The collimating lens focuses the returning light onto the laser diode.

A new type of external cavity lasers uses a focusing diffractive optical element (DOE) for collimation and focusing, as well as for wavelength-selective diffraction. Thus, the focusing DOE replaces the collimating lens and the diffraction grating of a conventional external cavity laser. The use of the focusing DOE not only reduces the number of optical components included in an external cavity laser, but also decreases the overall size of the external cavity laser.

A concern with using a focusing DOE in an external cavity laser is that a standard focusing DOE exhibits spherical aberration. Spherical aberration can degrade the performance of an external cavity laser by allowing light of multiple wavelengths to be resonant in the cavity. This can cause undesirable laser properties, such as mode hopping and multiple mode lasing.

In view of this concern, what is needed is an external cavity laser and method for selectively emitting light based on wavelength that uses a focusing DOE but reduces or eliminates the spherical aberration associated with the focusing DOE.

### SUMMARY OF THE INVENTION

An external cavity laser and method for selectively emitting light based on wavelength utilizes a focusing diffractive optical element (DOE) that has been corrected for spherical aberration. The use of the aberration-corrected focusing DOE narrows the cavity spectral response of the external cavity laser, which enables single wavelength/mode lasing and suppresses mode hopping. The aberration-corrected focusing DOE may be transmissive or reflective, depending on the configuration of the external cavity laser.

An external cavity laser in accordance with an embodiment of the invention includes an optical cavity, an optical gain medium, and an aberration-corrected focusing diffractive optical element. The optical gain medium is configured to generate light in the optical cavity, which is received by the diffractive optical element. The diffractive optical element is configured to diffractively focus the light of a selected wavelength back onto the optical gain medium to cause the light of the selected wavelength to resonate within the optical cavity. The external cavity laser may also include a reflective element that is optically coupled to the diffractive optical element to reflect at least some of the light from the diffractive optical element to the optical gain medium.

A method for selectively emitting light in accordance with an embodiment of the invention includes generating light, reflecting the light within an optical cavity, wavelength selectively diffracting the light within the optical cavity based on wavelength so that the light of a selected wavelength is resonant within the optical cavity, and emitting the selected wavelength light from the optical cavity as output light. The diffracting includes correcting the effects of an aberration related to diffraction.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of an external cavity laser in accordance with an embodiment of the present invention, illustrating the optical paths of light from an optical gain medium to a reflector.

FIG. 2 is another diagram of the external cavity of FIG. 1, illustrating the optical paths of light from the reflector back to the optical gain medium.

FIG. 3 is a front view of an aberration-corrected focusing diffractive optical element of the external cavity laser of FIG. 1.

FIG. 4 is a partial cross-section of the focusing diffractive optical element in accordance with an embodiment of the invention.

FIG. 5 illustrates the variables of a sag function for an aspheric surface.

FIG. 6A is a partial cross-section of a focusing diffractive optical element with circular gratings having a rectangular profile in accordance with an alternative embodiment of the invention.

FIG. 6B is a partial cross-section of a focusing diffractive optical element with circular gratings having a triangular profile in accordance with another alternative embodiment of the invention.

FIG. 6C is a partial cross-section of a focusing diffractive optical element with circular gratings having a sawtooth profile in accordance with another alternative embodiment of the invention.

FIG. 7 is a partial cross-section of a focusing diffractive optical element with sawtooth structures as circular gratings.

FIG. 8 is a diagram of an external cavity laser in accordance with another embodiment of the present invention.

FIG. 9 is a flow diagram of a method for selectively emitting light based on wavelength in accordance with an embodiment of the invention.

### DETAILED DESCRIPTION

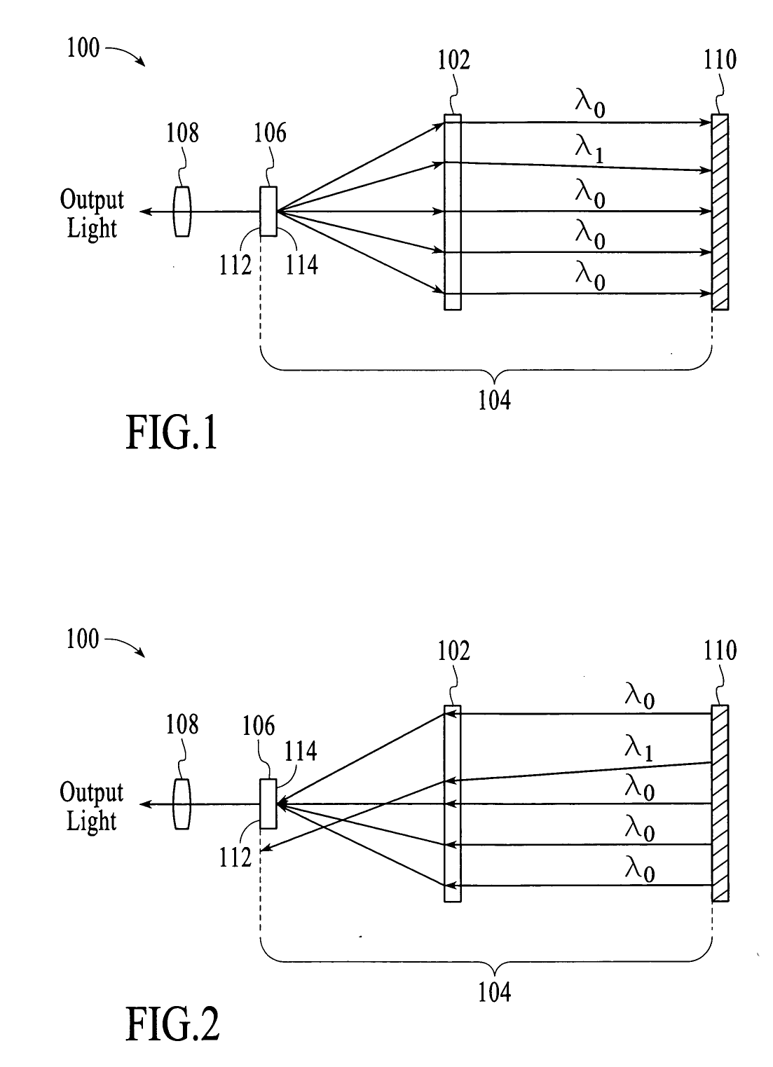

With reference to FIG. 1, an external cavity laser 100 in accordance with an embodiment of the invention is shown. The external cavity laser 100 includes an aberration-corrected transmissive focusing diffractive optical element (DOE) 102 to selectively diffract light within an optical external cavity 104 based on wavelength. The DOE 102 collimates light emitted by an optical gain medium 106 and focuses light reflected by a reflector 110 on the optical gain medium 106. The focusing DOE 102 replaces two or more optical elements of a conventional external cavity laser, such as a collimating lens and a diffraction grating. As described in more detail below, the focusing DOE 102 is corrected for spherical aberration. The aberration correction narrows the cavity spectral response of the external cavity laser 100, which enables single wavelength/single mode lasing and suppresses mode hopping. Thus, the optical performance of the external cavity laser 100 is significantly improved in comparison with an external cavity laser with a focusing DOE that has not been corrected for spherical aberration.

As shown in FIG. 1, the external cavity laser 100 includes the optical gain medium 106, the transmissive focusing DOE 102, and the reflector 110. The optical gain medium 106 may be any type of light source. Also shown is an optional output lens 108. The optical gain medium 106 is optically aligned to emit light towards the center of the focusing DOE 102. The light from the optical gain medium 106 is incident on the focusing DOE 102 at different locations with different angles of incidence. The optical gain medium 106 includes parallel surfaces 112 and 114. The surface 112 of the optical gain medium 106 may be uncoated or highly reflective (HR) coated, while the other surface 114 may be antireflection (AR) coated. The surface 112 of the optical gain medium 106 and the reflector 110 define the external cavity 104 that is resonant for light of a selected wavelength. The length of the external cavity 104 determines the resonant wavelength. Thus, the resonant wavelength can be tuned by moving the reflector 110 closer to or further from the optical gain medium 106. The surface 112 of the optical gain medium 106 is designed to allow a small percentage of the resonant light in the external cavity to be emitted from the external cavity 104 as output light. The output lens 108 is positioned to collimate the output light emitted from the optical gain medium 106. As used herein, light includes visible, infrared and/or ultraviolet light.

The transmissive focusing DOE 102 of the external cavity laser 100 is positioned between the optical gain medium 106 and the reflector 110. As an example, the focusing DOE 102 may be a transmissive Fresnel zone plate or a kinoform. The focusing DOE 102 functions as both a dispersing element and a focusing element. As illustrated in FIG. 1, for light propagating from the optical gain medium 106 towards the reflector 110, the focusing DOE 102 is structured to diffractively disperse the light based on wavelength such that light of a selected wavelength λ₀ is diffracted along an optical path that is normal to the reflector 110. The reflector 110 reflects the diffracted light back to the focusing DOE 102. Since the selected wavelength light propagates along optical paths that are normal to the reflector 110, the selected wavelength light is reflected back to the focusing DOE 102 along the same optical paths and is then focused onto the optical gain medium 106 by the focusing DOE 102, as illustrated in FIG. 2. In one embodiment, the reflector 110 is a planar mirror. In another embodiment, the reflector 110 is a retroreflector, such as an alignment insensitive retroreflector (e.g., a corner cube).

As shown in FIG. 2, for light propagating from the reflector 110 towards the optical gain medium 106, the focusing DOE 102 is structured to diffractively disperse the light based on wavelength such that only the light of the selected wavelength (λ₀) is focused on the optical gain medium. The overall diffractive effect of the focusing DOE 102 on the light propagating within the external cavity 104 is that only light of the selected wavelength returns to the optical gain medium 106 and is therefore resonant within the external cavity.

Resonant wavelength light within the external cavity 104 is defined as light of a wavelength that is able to make a roundtrip from the optical gain medium 106 to the planar mirror 110 and back to the optical gain medium. As illustrated in FIGS. 1 and 2, light of wavelength λ₀ propagates on optical paths from the optical gain medium 106 to the planar mirror 110 via the focusing DOE 102, and from the planar mirror back to the optical gain medium via the focusing DOE. Thus, the light of wavelength λ₀ is resonant within the external cavity 104. However, light of wavelength λ₁ propagates on an optical path that is not incident normally on the reflector 110 and therefore does not return to the optical gain medium 106. Thus, the light of wavelength λ₁ is not resonant within the external cavity 104.

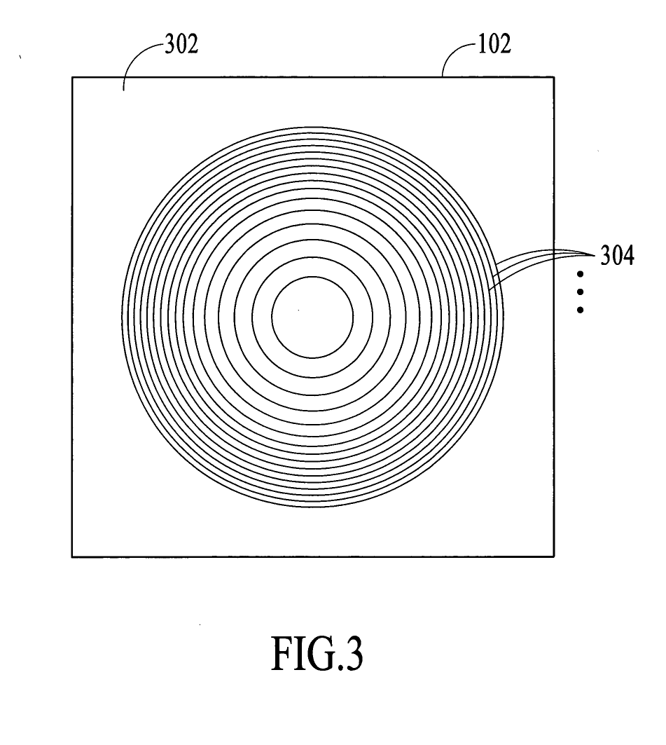

In FIG. 3, the surface 302 of the focusing DOE 102 that faces the optical gain medium 106 is shown. The surface 302 of the focusing DOE 102 includes concentric grating lines 304 that are separated by varying periodicities between the grating lines. Similar to other diffractive elements, the angle of diffraction for incident light on the focusing DOE 102 is governed by the following diffraction equation.

$$sin α \pm sin β = \frac{\pm n λ}{T}$$

where α is the angle of incidence, β is the angle of diffraction, n is the order of diffraction, λ is the wavelength of the incident light, and T is the period of the grating lines. Thus, the angle of diffraction for the focusing DOE 102 is dependent on the angle of incidence and the periodicities of the circular grating lines 304.

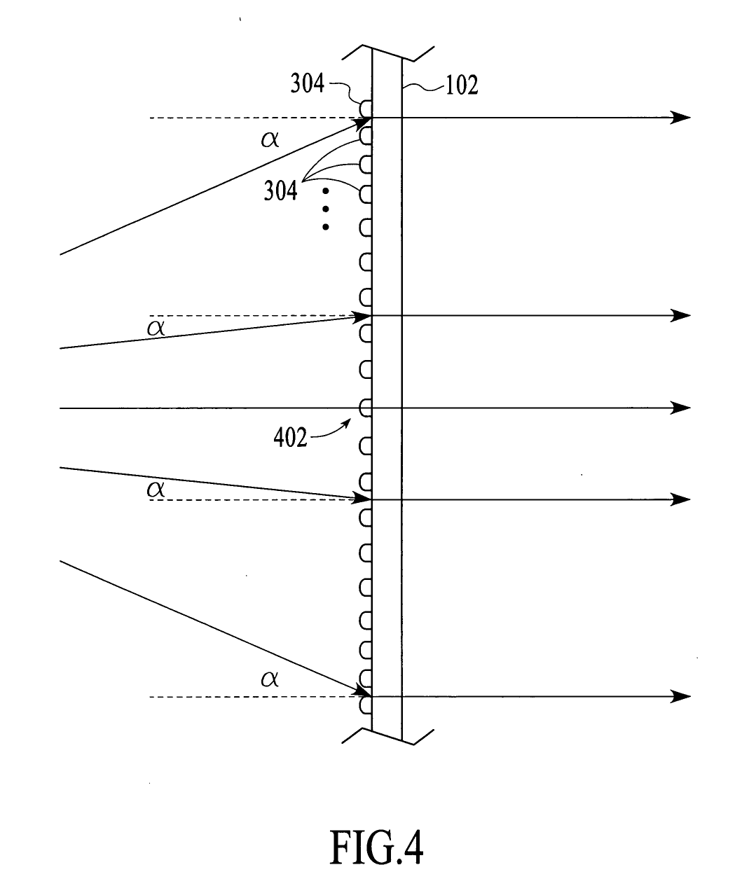

As stated above, due to dispersion, the light from the optical gain medium 106 will be incident on the focusing DOE 102 at different locations with different angles of incidence, as illustrated by a partial cross-section of the focusing DOE 102 in FIG. 4. The optical axis of the optical gain medium 106 is optically aligned with the center 402 of the focusing DOE 102. That is, the angle of incidence at the center 402 of the focusing DOE 102 is equal to zero. Therefore, the angle of incidence for light on the focusing DOE 102 will increase as the distance between the center 402 of the focusing DOE and the incident location on the focusing DOE increases, as illustrated in FIG. 4. Consequently, the incident light near the edges of the focusing DOE 102 will have larger angles of incidence than the incident light near the center 402 of the focusing DOE. Thus, using the diffraction equation, the periodicities of the focusing DOE 102 can be set to diffract light of the selected wavelength incident on the focusing DOE so that the selected wavelength light is diffracted onto optical paths that are normal to the planar mirror 110, regardless of the angle of incidence.

However, similar to a refractive lens, an embodiment of the focusing DOE 102 structured solely to diffract light, as just described, exhibits aberrations, especially spherical aberration. Thus, if the spherical aberration not corrected, some of the light incident on the focusing DOE 102 will depart from the expected diffracted optical path, especially light incident near the edge of the focusing DOE. Consequently, the spherical aberration of the focusing DOE 102 can cause a significant amount of light at wavelengths other than the desired wavelength to be resonant within the external cavity 104. As an example, if the focusing DOE 102 is not corrected for spherical aberration, the light of wavelength λ₁ shown in FIG. 2 may be diffractively focused back onto the optical gain medium 106. Thus, the light of wavelength λ₁ may also be resonant within the external cavity 104 in addition to the light of wavelength λ₀. As a result, the external cavity laser 100 may experience undesirable lasing properties, such as mode hopping and multiple mode lasing, as well as broad output spectrum. Furthermore, the spherical aberration of the focusing DOE 102 can cause light of the desired wavelength, e.g., light of wavelength λ₀ in FIG. 2, to miss the optical gain medium 106. Thus, less light of the desired wavelength will be resonant within the external cavity 104. This results in a reduced cavity gain at the desired wavelength.

Thus, the focusing DOE 102 is corrected for spherical aberration using a theoretical analysis to compensate for deviations in the angles of diffraction due to the spherical aberration of the focusing DOE. The aberration correction of the focusing DOE 102 involves adjusting the periodicities of the circular gratings 304, shown in FIG. 3, to selectively change the angles of diffraction in order to compensate for the deviations in the angles of diffraction caused by the spherical aberration of the focusing DOE.

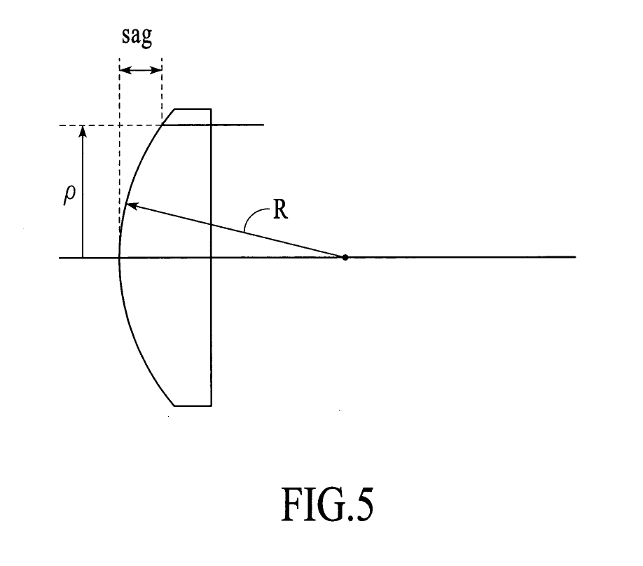

The periodicities of the circular gratings 304 of the focusing DOE 102 can be determined using the following technique. First, a hypothetical aspheric refractive surface is designed that has the desired optical properties of the aberration-corrected focusing DOE 102. The profile of this surface can be described mathematically by a sag function. For an aspheric surface, the sag function can be expressed as:

$$sag ( ρ ) = \frac{{ρ}^{2} / R}{1 + \sqrt{1 + ( 1 - ( \{ 1 + c \} \{ {ρ}^{2} / {R}^{2} \} )}} d {ρ}^{4} + e {ρ}^{6} + …$$

where the R is the radius of curvature of the surface at the surface vertex, c is the conic constant, which is equal to 0, −1 for a sphere or parabola at the vertex, d and e are aspheric coefficients, and p is the radius at a point on the surface, as illustrated in FIG. 5.

Next, a phase function that characterizes the aspheric refractive surface is constructed. This phase function can be mathematically expressed as:

$$ϕ ( ρ ) = \frac{2 π}{λ} ( n - 1 ) sag ( ρ )$$

where sag(p) is the sag function for the aspheric surface calculated as described above, n is the refractive index of the diffractive optical element, and λ is the wavelength.

The diffractive grating periodicities are found from the phase function φ(p) by the following equation:

$$∇ ( \frac{ϕ}{2 π m} ) = \frac{1}{Λ}$$

where m is the diffraction order, which is usually equal to one, and Λ is the grating periodicity function. Once the grating periodicities are known for all points on the aspheric surface, a diffractive optical element with the same aberration correcting performance of the aspheric refractive surface, i.e., the focusing DOE 102, can be fabricated.

Since the spherical aberration is corrected in the focusing DOE 102, the light at other than the desired wavelength that is resonant within the external cavity is significantly reduced. Thus, in the above example, the light of wavelength λ₁ is more likely to be diffractively focused to miss the optical gain medium 106, as illustrated in FIG. 2. Therefore, the resulting output light of the external cavity laser 100 will have a narrower spectrum than that of an external cavity laser with a standard (not aberration-corrected) focusing DOE.

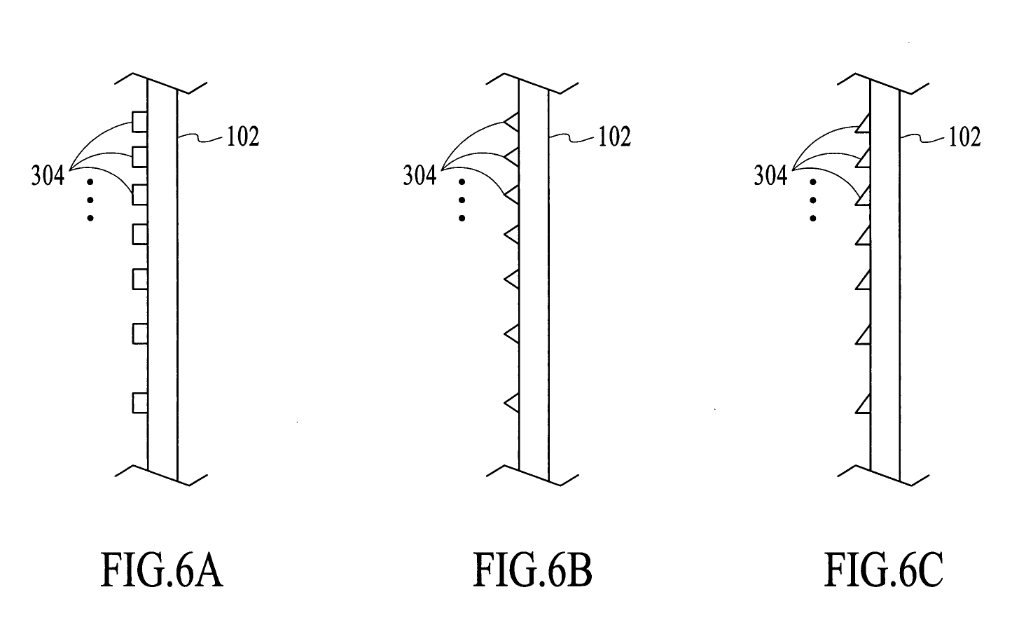

As illustrated in FIG. 4, each circular grating line 304 has a sinusoidal profile. A diffraction grating with such a grating profile is commonly referred to as a “sinusoidal” grating. However, the circular grating lines 304 of the focusing DOE 102 may have a different profile. As an example, the circular gratings 304 of the focusing DOE 102 may have a rectangular profile, as illustrated in FIG. 6A. A diffraction grating with such a grating profile is commonly referred to as a “ruled” grating. As another example, the circular gratings 304 of the focusing DOE 102 may have a triangular profile, as illustrated in FIG. 6B. As another example, the circular gratings 304 of the focusing DOE 102 may have a sawtooth profile, as illustrated in FIG. 6C. A diffraction grating with such a grating profile is commonly referred to as a “blazed” grating. A blazed grating diffracts most of the incident light into a particular diffraction order, usually the +1 or the −1 diffraction order. Thus, the diffraction efficiency of a blazed grating is greater than the diffraction efficiency of a sinusoidal or ruled grating.

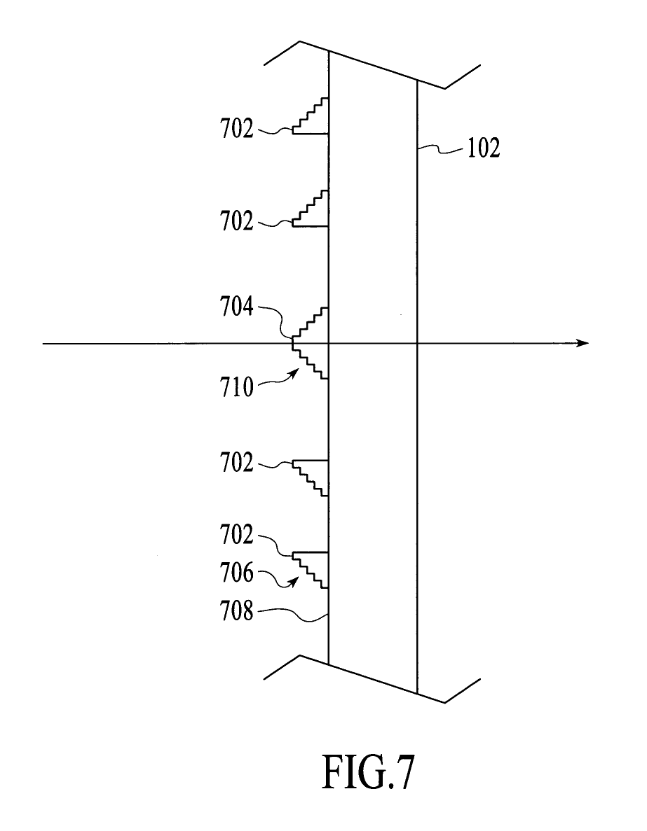

The transmissive focusing DOE 102 may be fabricated by selectively etching a suitable substrate to form the circular gratings. Suitable substrates include SiO₂, Si, GaAs, Ge and ZnSe substrates. As an example, dry chemical etching can be repeatedly performed on portions of the substrate that are exposed by patterned photo resist layers to form the circular gratings as sawtooth structures 702, including a sawtooth structure 704 located at the center of the focusing DOE 102, as illustrated in FIG. 7. As shown in FIG. 7, each sawtooth structure 702 includes a step-like feature 706 that ascends from a surface 708 of the focusing DOE 102, which partially defines a rough sawtooth profile. The center sawtooth structure 706 also includes a step-like feature 710. Since the sawtooth structure 704 is located at the center of the focusing DOE 102, the step-like feature 710 defines a rough triangular profile. The step-like features 706 and 710 of the sawtooth structures 702 and 704 can be formed by repeatedly performing dry chemical etching down to the surface 708 of the focusing DOE 102. Alternatively, the transmissive focusing DOE 102 may be fabricated by selectively polishing a suitable substrate using a single point diamond to form the sawtooth structures 702 and 704. The selective polishing can be performed by rotating the substrate and applying the single point diamond at different radial locations on the substrate to selectively remove portions of the substrate, forming the sawtooth structures 702 and 704 of the focusing DOE 102. The sawtooth structures can also be formed by depositing and then patterning layers of material, such as SiO₂, to build the sawtooth structures on a suitable substrate.

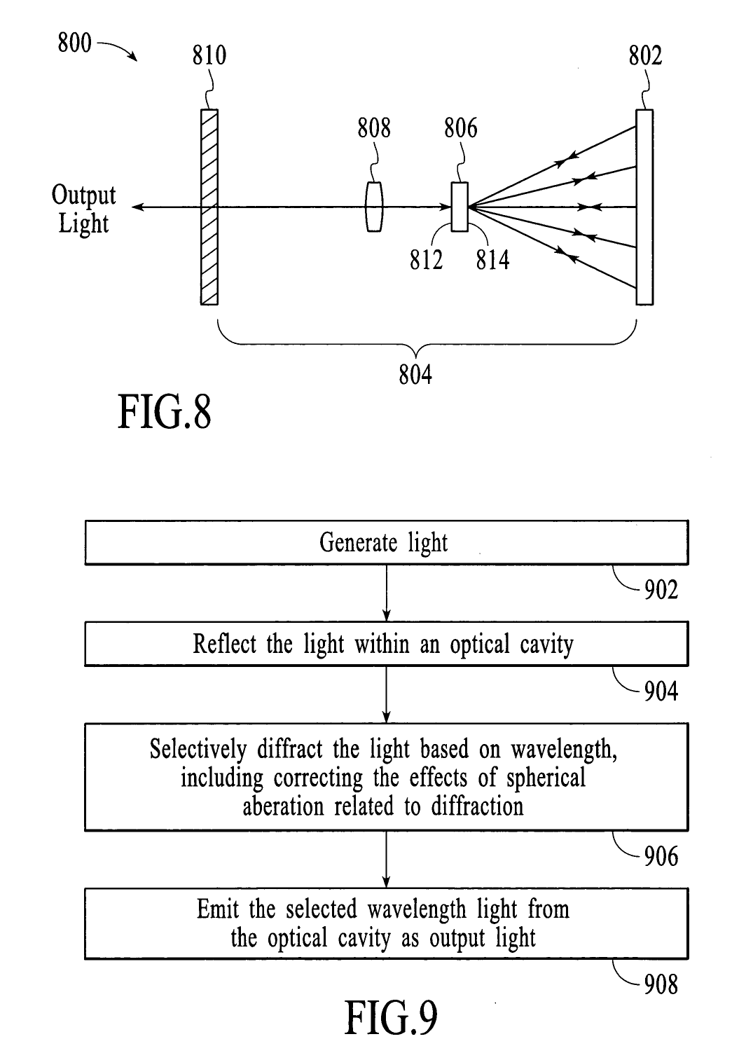

Turning now to FIG. 8, an external cavity laser 800 in accordance with another embodiment of the invention is shown. The external cavity laser 800 includes a partially transmissive reflector 810, a collimating lens 808, an optical gain medium 806 and a reflective focusing DOE 802. In this embodiment, the reflector 810 and the reflective focusing DOE 802 define the external cavity 804 of the laser 800.

As shown in FIG. 8, the collimating lens 808 and the optical gain medium 806 are positioned within the external cavity 804 such that the collimating lens 808 is between the reflector 810 and the optical gain medium. The collimating lens 808 collimates light from the optical gain medium 806 toward the partially transmissive reflector 810. At the partially transmissive reflector 810, some of the collimated light is transmitted through the reflector as output light, while some of the collimated light is reflected back to the optical gain medium 806 through the collimating lens 808. The partially transmissive reflector 810 may be a partially transmissive planar mirror or another type of partially transmissive reflective element, such as a partially transmissive retroreflector.

Similar to the optical gain medium 106 of FIGS. 1 and 2, the optical gain medium 806 is a light source that generates light toward the reflective focusing DOE 802. However, in contrast to the optical gain medium 106, the optical gain medium 806 includes parallel surfaces 812 and 814 that are both AR coated. Thus, light can easily propagate through the optical gain medium 806 via the AR coated surfaces 812 and 814.

The reflective focusing DOE 802 reflects and diffractively focuses light of a selected wavelength back to the optical gain medium 806 so that the selected wavelength light is resonant within the external cavity 804. Similar to the transmissive focusing DOE 102 of FIGS. 1 and 2, the reflective focusing DOE 802 includes circular gratings having a sinusoidal, ruled, triangular or sawtooth profile. In addition, the reflective focusing DOE 802 is corrected for spherical aberration so that less non-selected wavelength light is focused back onto the optical gain medium 806. The reflective focusing DOE 802 can be fabricated in a manner similar to the fabrication of the transmissive focusing DOE 102. As an example, the reflective focusing DOE 802 may be a reflective Fresnel zone plate or a reflective kinoform.

Since the wavelength of the resonant light within the external cavity 804 is determined by the length of the external cavity 804, the external cavity laser 800 can be tuned by moving the partially transmissive planar mirror 810 closer to or further from the optical gain medium 806. In an alternative embodiment, the reflective focusing DOE 802 and the surface 812 of the optical gain medium 806 may be used to define the external cavity 804, and thus, the partially transmissive reflector 810 is not needed. In this embodiment, the surface 812 of the optical gain medium 806 may be uncoated or highly reflective (HR) coated to partially reflect incident light. However, the resulting external cavity laser would not be tunable since the optical gain medium 806 or the reflective focusing DOE 802 cannot be moved due to the positional dependence of the reflective focusing DOE with respect to the optical gain medium 806 for proper focusing of light reflected by the DOE.

A method for selectively emitting light based on wavelength in accordance with an embodiment of the invention is described with reference to a flow diagram of FIG. 9. At block 902, light is generated. Next, at block 904, the light is reflected within an optical cavity. Next, at block 906, the light within the optical cavity is selectively diffracted based on wavelength so that a selected wavelength light is resonant within the optical cavity. Furthermore, at block 906, the effects of spherical aberration related to diffraction are corrected. Next, at block 908, the selected wavelength light is emitted from the optical cavity as output light.

Although specific embodiments of the invention have been described and illustrated, the invention is not to be limited to the specific forms or arrangements of parts so described and illustrated. The scope of the invention is to be defined by the claims appended hereto and their equivalents.

1. An optical device comprising:
an optical cavity;
an optical gain medium that generates light in said optical cavity; and
an aberration-corrected focusing diffractive optical element optically coupled to said optical gain medium to receive said light from said optical gain medium, said aberration-corrected focusing diffractive optical element being configured to diffractively focus said light of a selected wavelength back onto said optical gain medium to cause said light of said selected wavelength to resonate within said optical cavity.

2. The optical device of claim 1 wherein said aberration-corrected focusing diffractive optical element is configured to correct effects of spherical aberration.

3. The optical device of claim 2 wherein said aberration-corrected focusing diffractive optical element includes circular gratings separated by radius-dependent periodicities, said periodicities being based on an aspheric diffractive surface to compensate for deviations in angles of diffraction due to said spherical aberration.

4. The optical device of claim 3 wherein said circular gratings of said aberration-corrected focusing diffractive optical element have a profile selected from a sinusoidal profile, a rectangular profile, a triangular profile and a sawtooth profile.

5. The optical device of claim 1 further comprising a reflective element optically coupled to said aberration-corrected focusing diffractive optical element to reflect at least some of said light from said aberration-corrected focusing diffractive optical element to said optical gain medium.

6. The optical device of claim 5 wherein said aberration-corrected focusing diffractive optical element is transmissive.

7. The optical device of claim 6 wherein said aberration-corrected focusing diffractive optical element is positioned between said optical gain medium and said reflective element.

8. The optical device of claim 5 wherein said aberration-corrected focusing diffractive optical element is reflective.

9. The optical device of claim 8 wherein said optical gain medium is positioned between said reflective element and said aberration-corrected focusing diffractive optical element.

10. A method for selectively emitting light, said method comprising:
generating light;
reflecting said light within an optical cavity;
wavelength selectively diffracting said light within said optical cavity so that said light of a selected wavelength is resonant within said optical cavity, including correcting effects of an aberration related to said diffracting; and
emitting said light of said selected wavelength from said optical cavity as output light.

11. The method of claim 10 wherein said correcting includes correcting effects of spherical aberration related to said diffracting.

12. The method of claim 11 wherein said correcting includes compensating for deviations in angles of diffraction due to said spherical aberration using circular gratings separated by radius-dependent periodicities, said periodicities being based on an aspheric diffractive surface.

13. The method of claim 10 wherein said wavelength selectively diffracting includes transmitting said light within said optical cavity.

14. The method of claim 10 wherein said wavelength selectively diffracting includes reflecting said light within said optical cavity.

15. An optical device comprising:
a light source operable to generate light;
an aberration-corrected diffractive optical element configured to diffractively focus said light of a selected wavelength back onto said light source; and
means for reflecting at least some of said light from said focusing means to said light source, said reflecting means partially defining an optical cavity resonant at said light of said selected wavelength.

16. The optical device of claim 15 wherein said aberration-corrected diffractive optical element is configured to correct effects of spherical aberration.

17. The optical device of claim 16 wherein said aberration-corrected diffractive optical element includes circular gratings separated by radius-dependent periodicities, said periodicities being based on an aspheric diffractive surface to compensate for deviations in angles of diffraction due to said spherical aberration.

18. The optical device of claim 17 wherein said circular gratings of said aberration-corrected diffractive optical element have a profile selected from a sinusoidal profile, a rectangular profile, a triangular profile and a sawtooth profile.

19. The optical device of claim 17 wherein said aberration-corrected diffractive optical element is positioned between said light source and said reflecting means, said aberration-corrected diffractive optical element being transmissive.

20. The optical device of claim 15 wherein said light source is positioned between said aberration-corrected diffractive optical element and said reflecting means, said aberration-corrected diffractive optical element being reflective.
